(19) United States
(12) Patent Application Publication
(10) Pub. No.: US 2004/0170778 A1
(43) Pub. Date: Sep. 2, 2004

(54) Sheet for ink jet recording

(76) Inventors: Yoshihiko Tomita, Sodegaura-shi Chiba (JP); Masaya Kusumoto, Sodegaura-shi Chiba (JP); Tadashi Ishida, Sodegaura-shi Chiba (JP)

Correspondence Address: BURNS DOANE SWECKER & MATHIS L L P, POST OFFICE BOX 1404, ALEXANDRIA, VA, 22313-1404, US

(21) Appl. No.: 10/482,743

(22) PCT Filed: Jul. 17, 2002
(86) PCT No.: PCT/JP02/07265

(30) Foreign Application Priority Data
Jul. 17, 2001 (JP) 2001-216938

(51) Int. Cl. B32B 3/00

(52) U.S. Cl. 428/32.1

(57) ABSTRACT

A sheet for ink jet recording, comprising a sheet support and at least one ink receptive layer containing organic particles superimposed on a recording surface side of the sheet support, which sheet for ink jet recording has a recording surface exhibiting an angle of contact of dropped water with the recording surface, measured 10 sec after dropping of 4 μl of pure water on the recording surface, of 90° or more and exhibiting an angle of contact of dropped ink with the recording surface, measured 1 sec after dropping of 4 μl of ink on the recording surface, of 30° or less.

The provided sheet for ink jet recording is excellent in ink absorptivity, is excellent in color density, light fastness and yellowing resistance, and exhibits such a water repellency that print surface can be protected from water through repelling of water despite rapid absorption of inks.

### TECHNICAL FIELD

The present invention relates to a sheet for ink jet recording used in a printer or plotter wherein the ink jet recording system is utilized.

### BACKGROUND ART

The ink jet recording system comprises causing ink liquid droplets to fly according to various operating principles and stick to paper or other recording sheets to thereby attain recording of images, characters, etc. The ink jet recording system is characterized in that not only is realization of high speed, low noise and multicolor easy but also the flexibility of recording pattern is extensive and that neither development nor fixation is needed. Therefore, the use of ink jet recording system is rapidly spreading in various fields of application as recording devices for not only Chinese characters but also various graphics, color images, etc.

Further, with respect to the images formed by the multicolor ink jet recording system, records that are by no means inferior to multicolor prints through platemaking process and prints through color photography can be obtained as a result of enhancement of resolution and expansion of color reproduction range. In uses in which the number of copies prepared can be small, the application of multicolor ink jet recording system is widening to the field of full color image recording because of the cheapness as compared with photography.

With respect to printers or plotters utilizing the ink jet recording system, efforts are being made to attain an enhancement of resolution and an expansion of color reproduction range in accordance with the market demand for further image quality improvement. These are being coped with by increasing the amount of ink discharged. Accordingly, an increase of ink reception capacity in conformity with the amount of ink discharged is now an important technical task for recording sheets, and thus it is now indispensable to ensure high ink reception capacity and apply a coating layer of desirable color formation. In addition, it is demanded for appearances such as gloss, stiffness and hue to resemble those of silver salt photographic paper or color printing paper, and meeting these demands with conventional ink jet recording sheets of wood free paper and coated paper is becoming difficult.

In particular, in the conventional technology, imparting of gloss is accompanied by a problem such that the ink absorptivity being an important property demanded for sheets for ink jet recording would be deteriorated. For ensuring the ink absorptivity, it is needed to apply a coating layer of high void ratio, so that coating compositions for such a coating layer have been loaded with a high proportion of inorganic particles. However, the surface of coating layer becomes rough by the influence of inorganic particles, with the result that only sheets of low gloss, generally called matte tone, have been obtained.

With respect to the method of treatment for imparting gloss, it is common practice to pass sheets through a gap between pressurized heated rolls by means of calendering equipment, such as a supercalender or a gloss calender, so that the surface of coating layer is smoothed. However, when calendering is performed with the intent to impart gloss to sheets for ink jet recording, there would occur such a problem that, although gloss is improved, voids of the coating layer are reduced so as to retard ink absorption and to cause a deficiency of absorption capacity leading to failure to absorb ink and overflow to thereby invite bleeding. Therefore, calendering conditions must be chosen within the permitted range of ink absorption capacity, and it is now difficult to simultaneously attain realization of high ink absorptivity and imparting of gloss comparable to that of photographic paper by the use of the current technology of calendering.

Furthermore, for reconciling the ink absorptivity and the gloss being properties that conflict with each other, it has been proposed to load a coating layer with a large amount of minute inorganic particles and produce an ink jet recording sheet through a method known as cast coating method. However, it has been difficult for the proposed method to reconcile the ink absorptivity and the gloss being properties that conflict with each other in the ink jet printers or plotters of recent years wherein the amount of ink discharged is large. In a design placing emphasis on the ink absorptivity, for example, enhancing the ink absorptivity by using a large amount of inorganic particles so as to increase voids, it would be difficult to attain high gloss and there would occur a problem such as deterioration of surface strength. On the other hand, in a design placing emphasis on the gloss, for example, decreasing the amount of inorganic particles added, there would occur such a problem that voids are reduced to thereby render ensuring of ink absorptivity difficult although high gloss can be attained.

Generally, the ink solution for use in the ink jet recording system comprises a solvent composed of water as a main component and, dissolved therein, an anionic water-soluble dye. Therefore, in a design placing emphasis on the ink absorptivity, for example, enhancing the ink absorptivity by using a large amount of inorganic particles so as to increase voids, such a problem that the dye penetrates deep in the internal part of recording sheet so as to unfavorably result in a decrease of color density has been encountered (for increasing the color density, the dye of the ink must be immobilized at the surface layer of recording sheet as much as possible).

Moreover, it has been desired to enhance the water resistance of printed recording paper, namely, immobilize the dye on the surface layer of recording sheet so that when the recording sheet is brought into contact with water, detachment of the dye can be prevented. For resolving this problem, it has been proposed to employ a method wherein the coating layer is loaded with a cationic polymer so as to immobilize the anionic dye. However, this is accompanied by such a problem that an increase of the amount of cationic polymer leads to a decrease of the content of inorganic particles to thereby cause ensuring of the ink absorptivity to be difficult.

As apparent from the above, it has been difficult to obtain an ink jet recording paper that is excellent in a balance of gloss and ink absorptivity by the conventional method of employing a combination of cationic polymer and inorganic particles.

Japanese Patent Laid-open Publication No. 11(1999)-20304 discloses a medium for ink jet recording produced from a combination of alumina hydrate, a cationic urethane, a cationic resin obtained by reaction of a primary amine, a secondary amine and epihalohydrin, and benzethonium chloride. Japanese Patent Laid-open Publication No. 10(1998)-292137 discloses a recording medium comprising fine particles of a cationic crosslinked resin, which have an average particle diameter of 0.1 to 100 μm and exhibit a ratio of water absorption of not greater than 25 times the average particle diameter, and a binder resin.

Japanese Patent Laid-open Publication No. 11(1999)-20306 discloses a paper for ink jet recording, comprising a hydrophilic binder and a cationic mordant, the paper having an ink absorption layer whose film surface pH on the recording surface side is in the range of 3 to 5. Japanese Patent Laid-open Publication No. 10(1998)-264511 discloses a recording sheet having an ink absorption layer comprised of a cationic polymer having crosslinkable groups and a hydrophilic polymer. Japanese Patent Laid-open Publication No. 2000-94830 discloses a paper for ink jet recording characterized in that it is produced by mixing a solution of a cationic polymer with an inorganic fine particle dispersion wherein the inorganic fine particles have been dispersed into the state of primary particles, adding a water-soluble polymer to the mixture to thereby obtain a coating liquid and coating a support with the coating liquid. However, in all of these recording materials, the water resistance is realized by fixing ink dyes with cationic components, so that the deterioration of ink absorptivity is unpreventable. Further, because of the penetration of water into the recording medium, problems such as change of surface condition and deterioration of gloss have not yet been resolved.

Japanese Patent Laid-open Publication No. 11(1999)-123867 discloses an ink jet recording sheet characterized in that it has a white pigment layer loaded with a cationic acrylic resin emulsion obtained by copolymerizing an acrylic acid alkyl ester and/or a methacrylic acid alkyl ester with an aminated acrylic monomer. In this invention, a cationic acrylic resin emulsion is used as a binder in the white pigment layer. In this invention as well, ink dyes are fixed by cations to thereby exhibit water resistance.

Japanese Patent Laid-open Publication No. 10(1998)-203010 discloses a material coated with a hot melt coating composition. In this invention, after printing with a water-soluble ink, the coating composition is melted by heating to thereby protect print surface. By virtue of the melted coating composition, water penetration at print surface is inhibited with the result that excellent water resistance can be attained. However, the step of heating after printing is indispensable to thereby disenable use in common ink jet printers. This technique is limited to special uses.

Japanese Patent Laid-open Publication No. 2000-71608 discloses a recording medium comprising a substrate and, superimposed thereon, a porous ink receptive layer comprising thermoplastic resin particles and an inorganic pigment. This recording medium is capable of repelling water on the surface layer, so that the water resistance thereof is high. However, the water repelling effect is still unsatisfactory because of the incorporation of inorganic pigment in the porous ink receptive layer, and further there has been such a problem that high gloss cannot be expected because of the presence of inorganic pigment. Still further, it is described that the diameter of thermoplastic resin particles is substantially in the range of 1 to 100 μm. Thus, the particle diameter is large as compared with the wavelength of visible light, so that the print density is extremely reduced by light scattering to result in obtaining only indistinct prints.

Certainly, in recent years, the technological progress with respect to the ink jet recording system has enabled obtaining clear images and excellent print quality and has enabled obtaining image quality comparable to that of photography. However, as compared with photographs, there remains such a problem that the light fastness and yellowing resistance are unsatisfactory, thereby inviting fading of printed images and yellowing of recording sheet surface, for example, when the recording sheet has been stored for a prolonged period of time. Moreover, with respect to recording sheets of high gloss and ink absorptivity are now reconciled by loading the coating layer with a large amount of fine inorganic particles as aforementioned. For further performance enhancement, finer inorganic particles are increasingly selected. Generally, silica and alumina are preferably employed as inorganic particles. However, the surface area thereof is remarkably increased in accordance with the decrease of particle size to thereby enhance the surface activity of the inorganic particles with the result that there occurs a problem of causing marked deterioration of light fastness and yellowing resistance.

In summing up, it has been difficult to obtain a sheet for ink jet recording that satisfies all the requirements of high gloss, ink absorptivity, color density, water resistance, light fastness and yellowing resistance by the application of measures available in the current technology.

### OBJECT OF THE INVENTION

It is an object of the present invention to provide a sheet for ink jet recording that is excellent in ink absorptivity and excellent in color density, light fastness and yellowing resistance, in particular, exhibiting such a water repellency that print surfaces are protected from water by repelling thereof despite rapid absorption of inks.

### SUMMARY OF THE INVENTION

The inventors have conducted extensive and intensive investigations with a view toward solving the above problems of the prior art. As a result, it has been found that not only can gloss and ink absorptivity be reconciled but also a sheet for ink jet recording being excellent in color density, light fastness and yellowing resistance can be obtained by superimposing at least one layer containing hydrophobic organic particles on a sheet support on its recording surface side and by causing the recording surface to have specified liquid absorption characteristics. The present invention has been completed on the basis of this finding.

That is, the present invention is defined by the matter recited in the following items [1] to [7].

[1] A sheet for ink jet recording, comprising a sheet support and at least one ink receptive layer containing organic particles superimposed on a recording surface side of the sheet support, which sheet for ink jet recording has a recording surface exhibiting an angle of contact of dropped water with the recording surface, measured 10 sec after dropping of 4 μl of pure water on the recording surface, of 90° or more and exhibiting an angle of contact of dropped ink with the recording surface, measured 1 sec after dropping of 4 μl of ink on the recording surface, of 30° or less.

[2] The organic particles are those of at least one (co)polymer selected from among (meth)acrylic polymers ((meth)acrylic ester (co)polymers), styrene-(meth)acrylic polymers (styrene-(meth)acrylic ester copolymers), styrene polymers (styrene or styrene derivative (co)polymers), MBR polymers (methyl methacrylate-butadiene copolymer), SBR polymers (styrene-butadiene copolymer), urethane polymers, epoxy polymers, EVA polymers (ethylene-vinyl acetate copolymer), melamine polymers, urea polymers and olefinic polymers.

[3] The organic particles are emulsion particles obtained by copolymerizing at least one monomer (A) selected from among styrene, t-butyl methacrylate, isobornyl acrylate, isobornyl methacrylate and isopropyl methacrylate with another monomer copolymerizable therewith (B).

[4] Providing that the total weight of monomer (A) and monomer (B) constitutes 100%, the monomer (A) is used in an amount of 50 to 100% by weight while the monomer (B) is used in an amount of 0 to 50% by weight.

[5] The copolymerizable monomer (B) does not contain any cationic monomer, and the organic particles are those polymerized with the use of a cationic initiator.

[6] The organic particles of items [1] to [5] above are cationic organic particles.

[7] The layer containing organic particles does not contain any inorganic pigment.

### BEST MODE FOR CARRYING OUT THE INVENTION

The sheet for ink jet recording according to the present invention is a recording sheet comprising at least one layer containing organic particles on a sheet support characterized in that the recording sheet exhibits specified liquid absorption characteristics.

The present invention will be described in detail below.

[Method of Measuring Contact Angle]

First, the method of measuring a contact angle according to the present invention will be described.

In the measuring of the angle of contact of dropped water or ink with the recording sheet according to the present invention, 4 μl of liquid drop of pure water or ink is attached perpendicularly to a recording surface of recording sheet held horizontally in an atmosphere of 20° C. and 65% RH. With respect to pure water, the angle of contact of water drop with the recording surface is determined 10 sec after the drop attachment. With respect to ink, the angle of contact of ink drop with the recording surface is determined 1 sec after the drop attachment.

The contact angle refers to the compatibility or conformability of dropped liquid with the individual in contact therewith, namely the recording sheet in this instance. When the contact angle is 90° or greater, there is no conformability between dropped liquid and the individual in contact therewith, so that the liquid is repelled. For example, with respect to the sheet for ink jet recording, dropped liquid is not absorbed at all in the sheet when the contact angle is 90° or greater. When the contact angle is not greater than 90°, the smaller the contact angle, the higher the absorptivity.

The contact angle can be measured by means of, for example, DAT (Dynamic Absorptivity Tester) model 1100 or DAT MK11 manufactured by FIBRO. First, 4 μl of pure water or ink drop is caused to fall onto the recording surface of the recording sheet, and the state thereof after the dropping is captured on video. Thereafter, the angle of contact of liquid drop with the recording surface of the recording sheet is gauged on the video image after a predetermined period of time.

In the present invention, pure water used in the measuring of contact angle can be any one purified by common pure water producing apparatus. For example, pure water purified by AUTO still WG55 (manufactured by Yamato Scientific Co., Ltd.) can be used.

A water base ink for ink jet recording containing an anionic dye and an organic compound can be employed as the ink for use in the measuring of contact angle.

As the anionic dye, there can be mentioned, for example, an acid dye such as a metal complex dye, a nitro dye, a carbonium dye, an anthraquinone dye or an azo dye having an anionic group such as a sulfonate group or a carboxylate group. Any one thereof can be used as the dye for measurement.

The above anionic dye may be contained in the ink for measurement in a concentration of 0.1 to 15% by weight.

Any organic compounds as contained in commercially available water base inks for ink jet recording can be used without any particular limitation as the organic compound to be contained in the water base ink for measuring. There can be mentioned, for example, a glycol such as diethylene glycol or ethylene glycol; a glycol ether such as triethylene glycol monobutyl ether; a pyrrolidone such as N-methyl-2-pyrrolidone or 2-pyrrolidone; a lubricant such as glycerol; a pH adjusting agent such as a metal hydroxide/amine; a surfactant; and a penetrant such as an acetylene glycol compound.

Although the amount of these organic compounds contained for measuring is not particularly limited, it may appropriately range from 10 to 40% by weight.

As long as the above requirements are satisfied, the water base ink for measuring is not particularly limited. For example, there can be mentioned the cyan ink of color ink cartridge (IC5CL05) usable in EPSON PM-800C.

It is desired for the sheet for ink jet recording not only to have the property of rapidly absorbing inks but also to repel water on the surface, namely, exhibiting water repellency from the viewpoint of the water resistance of printed images.

With respect to the recording sheet of the present invention, when 4 μl of pure water drop is attached perpendicularly to the recording surface, the contact angle measured 10 sec after the drop attachment is 90° or greater. Preferably the contact angle measured 30 sec after the drop attachment is 90° or greater. Still preferably the contact angle measured 1 min after the drop attachment is 90° or greater. When the contact angle is less than 90°, water begins to penetrate as soon as it sticks to the surface of the recording sheet, so that the conditions of recording sheet surface and printed portion may be changed to thereby cause bleeding and color dulling. Thus, the water resistance is unsatisfactory.

With respect to the period of time passing until the contact angle exhibits 90°, 10 sec or more is preferred from the viewpoint of the time required for practical operation from application of water to the recording sheet to wiping the water off.

When 4 μl of ink drop is attached perpendicularly to the recording surface, the contact angle measured 1 sec after the drop attachment is 30° or less. Preferably the contact angle is 20° or less. Still preferably the contact angle measured 0.5 sec after the drop attachment is 20° or less. When the contact angle measured 1 sec after the drop attachment exceeds 30°, the ink absorption rate satisfactory for the sheet for ink jet recording may not be attained.

[Sheet Support]

In the present invention, as the support, use can be made of supports conventionally employed in ink jet recording sheets, for example, a paper support such as plain paper, art paper, coated paper, cast coated paper, resin coated paper, resin impregnated paper, noncoated paper or coated paper, a paper support having its both sides or one side coated with polyethylene and/or a polyolefin such as polyethylene having titanium or other white pigment milled therein, a plastic support, a nonwoven fabric, a cloth, a woven fabric, a metal film, a metal plate, and a composite support consisting of a laminate of these.

As the plastic support, there can preferably be used, for example, a sheet or film of plastic such as polyethylene, polypropylene, polystyrene, polyethylene terephthalate, polyethylene naphthalate, triacetylcellulose, polyvinyl chloride, polyvinylidene chloride, polyimide, polycarbonate, cellophane or polynylon. Among these plastic supports, transparent, translucent, or opaque ones can appropriately be selected according to intended use.

It is also preferred to use a white plastic film as the support. As the white plastic support, use can be made of a support constituted of a plastic compounded with a small amount of white pigment such as barium sulfate, titanium oxide or zinc oxide, a foamed plastic support provided with translucency by forming a multiplicity of minute voids, or a support furnished with a layer containing a white pigment (e.g., titanium oxide or barium sulfate).

In the present invention, although the configuration of the support is not limited, not only customarily employed films, sheets and plates but also cylindrical form such as that of a drink can, disc form as that of CD or CD-R and other complex forms can be used as the support.

[Layer Containing Organic Particle]

In the present invention, at least one layer containing organic particles is superimposed on the recording surface side of the above sheet support organic particle

It is preferred that the organic particles for use in the present invention exhibit high affinity with water base inks and be highly hydrophobic.

Emulsion particles obtained by copolymerizing at least one monomer (A) selected from among styrene, t-butyl methacrylate, isobornyl acrylate, isobornyl methacrylate and isopropyl methacrylate with another monomer copolymerizable therewith (B) are preferred as the above organic particles from the viewpoint that the hydrophobicity ascribed to the monomer (A) is high to thereby exhibit high water repellency.

Further, the organic particles polymerized using 50 to 100% by weight of monomer (A) and 0 to 50% by weight of monomer (B), preferably 65 to 100% by weight of monomer (A) and 0 to 35% by weight of monomer (B), and still preferably 80 to 100% by weight of monomer (A) and 0 to 20% by weight of monomer (B) on the basis of the total weight of monomer (A) and monomer (B) can exert more conspicuous hydrophobic effect ascribed to the monomer (A) to thereby enable exhibiting higher water repellency.

The copolymerizable monomer (B) preferably has at least one double bond capable of copolymerization with the monomer (A) The preferred copolymerizable monomer (B) can be, for example, any of:

acrylic acid esters such as methyl acrylate, ethyl acrylate, isopropyl acrylate, n-butyl acrylate, isobutyl acrylate, n-amyl acrylate, isoamyl acrylate, n-hexyl acrylate, 2-ethylhexyl acrylate, octyl acrylate, decyl acrylate, dodecyl acrylate, octadecyl acrylate, cyclohexyl acrylate, phenyl acrylate, benzyl acrylate and other alkyl acrylates each having 1 to 12 carbon atoms;

methacrylic acid esters such as methyl methacrylate, ethyl methacrylate, isopropyl methacrylate, n-butyl methacrylate, isobutyl methacrylate, n-amyl methacrylate, isoamyl methacrylate, n-hexyl methacrylate, 2-ethylhexyl methacrylate, octyl methacrylate, decyl methacrylate, dodecyl methacrylate, octadecyl methacrylate, cyclohexyl methacrylate, phenyl methacrylate, benzyl methacrylate and other alkyl methacrylates each having 1 to 12 carbon atoms;

aromatic vinyls such as 2-methylstyrene, t-butylstyrene, chlorostyrene, vinylanisole, vinylnaphthalene and divinylbenzene;

unsaturated carboxylic acids such as acrylic acid, methacrylic acid, itaconic acid, maleic acid, fumaric acid, acrylic anhydride, methacrylic anhydride, maleic anhydride, itaconic anhydride and fumaric anhydride;

hydroxylated vinyls such as 2-hydroxyethyl acrylate, hydroxypropyl acrylate, 4-hydroxybutyl acrylate, 2-hydroxyethyl methacrylate, hydroxypropyl methacrylate and 4-hydroxybutyl methacrylate;

amides such as acrylamide, methacrylamide, N-methylolmethacrylamide, N-methylolacrylamide, diacetonacrylamide and maleamide;

vinyl esters such as vinyl acetate and vinyl propionate;

vinylidene halides such as vinylidene chloride and vinylidene fluoride;

aminoalkyl acrylates and aminoalkyl methacrylates such as N,N-dimethylaminoethyl acrylate, N,N-dimethylaminoethyl methacrylate, N,N-dimethylaminopropyl acrylate, N,N-dimethylaminopropyl methacrylate, N,N-di-t-butylaminoethyl acrylate, N,N-di-t-butylaminoethyl methacrylate, N,N-monomethylaminoethyl acrylate and N,N-monomethylaminoethyl methacrylate;

N-aminoalkylacrylamides and N-aminoalkylmethacrylamides such as N,N-dimethylacrylamide, N,N-dimethylmethacrylamide, N,N-diethylacrylamide, N,N-diethylmethacrylamide, N,N-dimethylaminopropylacrylamide, N,N-dimethylaminopropylmethacrylamide, N,N-dimethylaminoethylacrylamide, N,N-dimethylaminoethylmethacrylamide and N-isopropylacrylamide;

quaternary onium salts of aminoalkyl acrylates, aminoalkyl methacrylates, N-aminoalkylacrylamides and N-aminoalkylmethacrylamides listed above converted to quaternary onium salts by a halogenated methyl group, a halogenated ethyl group, a halogenated benzyl halide group or the like wherein the halogen is, for example, chlorine, bromine or iodine;

acryloylmorpholine, 2-(2′-hydroxy-5′-methacryloyloxyethylphenyl)-2H-benzotriazole, 2-(2′-hydroxy-5′-methacryloyloxyphenyl)benzotriazole, 2-hydroxy-4-(2-methacryloyloxy)ethoxybenzophenone, 2-(2′-hydroxy-5′-methacryloyloxyphenyl)-5-chlorobenzotriazole, 1,2,2,6,6-pentamethyl-4-piperidinyl methacrylate, 2,2,6,6-tetramethyl-4-piperidinyl methacrylate and the like; and

vinyl chloride, vinyl ether, vinyl ketone, vinylamide, chloroprene, ethylene, propylene, isoprene, butadiene, chloroprene, vinylpyrrolidone, 2-methoxyethyl acrylate, 2-ethoxyethyl acrylate, glycidyl acrylate, glycidyl methacrylate, allyl glycidyl ether, acrylonitrile, methacrylonitrile, ethylene glycol dimethacrylate, diethylene glycol dimethacrylate, triethylene glycol dimethacrylate, polyethylene glycol dimethacrylate, polypropylene glycol dimethacrylate, neopentyl glycol dimethacrylate, 1,3-butylene glycol dimethacrylate, 1,6-hexanediol dimethacrylate, neopentyl glycol dimethacrylate, polyethylene glycol diacrylate, 1,6-hexanediol diacrylate, neopentyl glycol diacrylate, tripropylene glycol diacrylate, polypropylene glycol diacrylate, trimethylolpropane trimethacrylate, trimethylolpropane triacrylate, tetramethylolmethane triacrylate, tetramethylolmethane tetraacrylate, allyl methacrylate, dicyclopentenyl acrylate, dicyclopentenyloxyethyl acrylate, isopropenyl-α, α-dimethylbenzyl isocyanate, allylmercaptan and the like.

The organic particles may be those produced from any one of these monomers, or a mixture of two or more of these monomers.

Among the monomers, those having polar groups are preferred from the viewpoint of capability of controlling the average diameter of organic particles within a specified range as described later.

With respect to the properties of organic particles, since the dye is anionic, those exhibiting cationic property capable of strong interaction with the dye are preferred from the viewpoint of high print density. However, the use of highly cationic monomer may render the hydrophilicity of particles per se so high that imparting of hydrophobicity is difficult.

Therefore, in the present invention, the organic particles having been cationized through polymerization using a non-cationic monomer as the monomer (B) but using a cationic initiator as described later are preferred from the viewpoint that not only is the hydrophobicity high so as to exhibit excellent water repellency but also the affinity with dyes is high.

Hydroxylated monomers such as 2-hydroxyethyl methacrylate are preferably used as the monomer (B) in the present invention.

With respect to preferred combinations of monomers (A) and (B), there can be mentioned one wherein the monomer (A) is styrene and/or t-butyl methacrylate while the monomer (B) is 2-hydroxyethyl methacrylate. When it is intended to control the glass transition temperature, further using n-butyl acrylate and/or 2-ethylhexyl acrylate as the monomer (B) is preferred.

The weight average molecular weight of organic particles for use in the present invention is preferably 10,000 or more, still preferably 30,000 or more, and yet still preferably 50,000 or more. The upper limit of weight average molecular weight is 2000 thousand, preferably 1000 thousand.

When the weight average molecular weight is less than 10,000, the deformation of organic particles may be likely to occur to thereby reduce voids with the result that the ink absorptivity of recording sheet may be deteriorated.

The average diameter of organic particles is preferably in the range of 10 to 300 nm, still preferably 10 to 200 nm, and yet still preferably 10 to 150 nm. When the average diameter is less than 10 nm, fine voids may be reduced so as to result in deterioration of ink absorptivity. On the other hand, when the average diameter exceeds 300 nm, the transparency of the layer containing the organic particles may be lowered to result in a decrease of print density. When the organic particles of average diameter falling within the above extremely restrictive range are employed, not only is the transparency of the layer containing the organic particles high so as to realize high print density but also appropriate pores can be formed for ink absorption so as to realize enhanced ink absorptivity.

In the present invention, practically, the particle diameter is measured by the use of laser particle diameter analyzing system LPA-3000/3100 (manufactured by Otsuka Electronics Co., Ltd.).

The glass transition temperature of organic particles is preferably 40° C. or higher, still preferably 60° C. or higher. The upper limit of glass transition temperature is 300° C., preferably 250° C.

When the glass transition temperature is below 65° C., minute voids of the surface layer may tend to be reduced to result in a decrease of ink absorptivity. Further, when a coating layer is dried, because high drying temperature would reduce fine voids, the drying temperature must be low to thereby invite the possibility of production efficiency decrease. The glass transition temperature can be determined from DSC curves in accordance with Japanese Industrial Standard (JIS) K 7121.

Process for Producing Organic Particles

The above organic particles can be produced from the above components (A) and (B) by the known emulsion polymerization process or mechanical emulsification process. For example, in the emulsion polymerization process, there can be employed a method wherein monomers are continuously fed and polymerized and a method wherein various monomers are simultaneously charged and polymerized in the presence of a dispersant and an initiator. In the emulsion polymerization process, the polymerization temperature is generally in the range of 30 to 90° C. Thus, substantially a water dispersion of organic particles, generally referred to as “emulsion”, can be obtained. The water dispersion of organic particles obtained by the emulsion polymerization process is highly stable in the presence of a small amount of dispersant and is excellent in that organic particles of extremely small diameter can be easily obtained.

The initiator for use in the polymerization can be any of common radical initiators, for example, hydrogen peroxide; persulfates such as ammonium persulfate and potassium persulfate; organic peroxides such as cumene hydroperoxide, t-butyl hydroperoxide, benzoyl peroxide, t-butyl peroxy-2-ethylhexanoate, t-butyl peroxybenzoate and lauroyl peroxide; azo compounds such as azobisisobutyronitrile, 2,2′-azobis(2-amidinopropane) dihydrochloride, 2,2′-azobis[2-(N-phenylamidino)propane] dihydrochloride, 2,2′-azobis{2-[N-(4-chlorophenyl)amidino]propane} dihydrochloride, 2,2′-azobis{2-[N-(4-hydroxyphenyl)amidino]propane} dihydrochloride, 2,2′-azobis[2-(N-benzylamidino)propane] dihydrochloride, 2,2′-azobis[2-(N-allylamidino)propane] dihydrochloride, 2,2′-azobis{2-[N-(2-hydroxyethyl)amidino]propane} dihydrochloride, 2,2′-azobis{2-methyl-N-[1,1-bis(hydroxymethyl)-2-hydroxyethyl]propionamido}, 2,2′-azobis{2-methyl-N-[1,1-bis(hydroxymethyl)ethyl]propionamido}, 2,2′-azobis[2-methyl-N-(2-hydroxyethyl)propionamido] and 2,2′-azobis(isobutylamido) dihydrate; and redox initiators consisting of a mixture of any of these, a metal ion, such as iron ion, and a reducing agent, such as sodium sulfoxylate, formaldehyde, sodium pyrosulfite, sodium hydrogen sulfite, L-ascorbic acid or rongalite. One, or two or more members can be selected from among these initiators.

Among these initiators, cationic polymerization initiators are preferred. In particular, at least one initiator selected from the group consisting of 2,2′-azobis(2-amidinopropane) dihydrochloride, 2,2′-azobis[2-(N-phenylamidino)propane] dihydrochloride, 2,2′-azobis{2-[N-(4-chlorophenyl)amidino]propane} dihydrochloride, 2,2′-azobis{2-[N-(4-hydroxyphenyl)amidino]propane} dihydrochloride, 2,2′-azobis[2-(N-benzylamidino)propane] dihydrochloride, 2,2′-azobis[2-(N-allylamidino)propane] dihydrochloride, 2,2′-azobis[2-[N-(2-hydroxyethyl)amidino]propane} dihydrochloride and the like is preferred.

With respect to these polymerization initiators, it is preferred that the amount of initiator used be in the range of 0.01 to 20% by weight, especially 0.1 to 10% by weight, based on the total weight of monomers copolymerized.

Examples of preferably used dispersants include a cationic surfactant, a nonionic surfactant, an anionic surfactant, a cationic water-soluble polymer, a nonionic water-soluble polymer and an anionic water-soluble polymer. One, or two or more members can be selected from among these. These dispersants will be described in detail below.

As the cationic surfactant, there can be mentioned, for example, lauryltrimethylammonium chloride, stearyltrimethylammonium chloride, cetyltrimethylammonium chloride, distearyldimethylammonium chloride, alkylbenzyldimethylammonium chloride, laurylbetaine, stearylbetaine, lauryldimethylamine oxide, laurylcarboxymethylhydroxyethylimidazolinium betaine, coconut amine acetate, stearylamine acetate, alkylamine guanidine polyoxyethanol, alkylpicolinium chloride or the like. One, or two or more members can be selected from among these.

As the nonionic surfactant, there can be mentioned, for example, polyoxyethylene lauryl ether, polyoxyethylene octylphenyl ether, polyoxyethylene oleylphenyl ether, polyoxyethylene nonylphenyl ether, oxyethylene/oxypropylene block copolymer, tert-octylphenoxyethylpolyethoxyethanol, nonylphenoxyethylpolyethoxyethanol or the like. One, or two or more members can be selected from among these.

As the anionic surfactant, there can be mentioned, for example, sodium dodecylbenzenesulfonate, sodium lauryl sulfate, sodium alkyl diphenyl ether disulfonate, sodium alkylnaphthalenesulfonate, sodium dialkylsulfosuccinate, sodium stearate, potassium oleate, sodium dioctylsulfosuccinate, sodium polyoxyethylene alkyl ether sulfate, sodium polyoxyethylene alkyl ether sulfate, sodium polyoxyethylene alkylphenyl ether sulfate, sodium dialkylsulfosuccinate, sodium oleate, sodium tert-octylphenoxyethoxypolyethoxyethyl sulfate or the like. One, or two or more members can be selected from among these.

As the cationic water soluble polymer, there can be mentioned, for example, a cationized polyvinyl alcohol, a cationized starch, a cationized polyacrylamide, a cationized polymethacrylamide, polyamidopolyurea, polyethyleneimine, a copolymer of allylamine or its salt, an epichlorohydrin/dialkylamine adduct polymer, a polymer of diallylalkylamine or its salt, a polymer of diallyldialkylammonium salt, a copolymer of diallylamine or its salt and sulfur dioxide, a diallyldialkylammonium salt/sulfur dioxide copolymer, a copolymer of diallyldialkylammonium salt and diallylamine or its salt or a derivative thereof, a diallyldialkylammonium salt/acrylamide copolymer, an amine/carboxylic acid copolymer, a dialkylaminoethyl (meth)acrylate polymer or an N-aminoalkyl(meth)acrylamide polymer. One, or two or more members can be selected from among these.

As the dialkylaminoethyl (meth)acrylate polymer or N-aminoalkyl(meth)acrylamide polymer, there can be mentioned, for example, a homopolymer or copolymer produced from an aminoalkyl acrylate or aminoalkyl methacrylate such as N,N-dimethylaminoethyl acrylate, N,N-dimethylaminoethyl methacrylate, N,N-dimethylaminopropyl acrylate, N,N-dimethylaminopropyl methacrylate, N,N-di-t-butylaminoethyl acrylate, N,N-di-t-butylaminoethyl methacrylate, N,N-monomethylaminoethyl acrylate or N,N-monomethylaminoethyl methacrylate; an N-aminoalkylacrylamide or N-aminoalkylmethacrylamide such as N, N-dimethylaminopropylacrylamide, N, N-dimethylaminopropylmethacrylamide, N,N-dimethylaminoethylacrylamide or N,N-dimethylaminoethylmethacrylamide; and/or a monomer consisting of any of these converted to a quaternary salt with a halogenated methyl group, a halogenated ethyl group, a halogenated benzyl group or the like.

As the nonionic water soluble polymer, there can be mentioned, for example, polyvinyl alcohol or its derivative; a starch derivative such as oxidized starch, etherified starch or phosphated starch; polyvinylpyrrolidone or a polyvinylpyrrolidone derivative such as polyvinylpyrrolidone obtained by copolymerization with vinyl acetate; a cellulose derivative such as carboxymethylcellulose or hydroxymethylcellulose; polyacrylamide or its derivative; polymethacrylamide or its derivative; or gelatin, casein or the like. One, or two or more members can be selected from among these.

As the anionic water soluble polymer, there can be mentioned, for example, any of polyalginic acid or its metal salt; carboxymethylcellulose or its metal salt; polyacrylic acid or its metal salt; a partial hydrolyzate of polyacrylamide or its metal salt; a maleic acid copolymer; lignin sulfonic acid or its metal salt or a derivative thereof; an oxy organic acid or its metal salt; an alkylallylsulfonic acid or its metal salt; a polyoxyalkyl allyl ether; a polyol complex; a higher polyhydric alcohol sulfonic acid or its metal salt; and a water soluble protein such as gelatin or glue or its metal salt or a derivative thereof. One, or two or more members can be selected from among these.

Although the amount of dispersant used is not particularly limited, it is generally preferred that the amount be in the range of 0.02 to 5% by weight, especially 0.02 to 10% by weight, and yet still especially 0.02 to 5% by weight based on the total weight of monomers copolymerized.

Further, according to necessity, a mercaptan such as t-dodecylmercaptan or n-dodecylmercaptan, an allyl compound such as allylsulfonic acid, methallylsulfonic acid or a sodium salt thereof, or the like can be used as a molecular weight modifier.

Still further, according to necessity, sulfuric acid, hydrochloric acid, nitric acid, sodium hydroxide, potassium hydroxide, magnesium sulfate, potassium sulfate, aluminum sulfate, sodium acetate, magnesium acetate, potassium acetate, ammonia, triethanolamine, diethanolamine, monoethanolamine, etc. can be used as a pH adjuster.

Constitution of Layer Containing Organic Particles

The content of organic particles based on the total solid contained in the layer containing organic particles according to the present invention may be in the range of 60 to 100% by weight. When the content of organic particles falls within this range, a recording sheet of high water repellency can be obtained.

In order to enhance the surface strength and gloss, the layer containing organic particles according to the present invention may be loaded with a polymer having binder functions. As the polymer having binder functions, there can be mentioned, for example, water soluble polymers or a water dispersion of water insoluble polymer. These will be described in detail below.

The water soluble polymers include, for example, cationic water soluble polymers such as a cationized polyvinyl alcohol, a cationized starch, a cationized polyacrylamide, a cationized polymethacrylamide, polyamidopolyurea, polyethyleneimine, a copolymer of allylamine or its salt, an epichlorohydrin/dialkylamine adduct polymer, a polymer of diallylalkylamine or its salt, a polymer of diallyldialkylammonium salt, a copolymer of diallylamine or its salt and sulfur dioxide, a diallyldialkylammonium salt/sulfur dioxide copolymer, a copolymer of diallyldialkylammonium salt and diallylamine or its salt or a derivative thereof, a polymer of dialkylaminoethyl acrylate quaternary salt, a diallyldialkylammonium salt/acrylamide copolymer and an amine/carboxylic acid copolymer.

Further, the water soluble polymers include nonionic water soluble polymers such as polyvinyl alcohol or its derivative; a starch derivative such as oxidized starch, etherified starch or phosphated starch; polyvinylpyrrolidone or a polyvinylpyrrolidone derivative such as polyvinylpyrrolidone obtained by copolymerization with vinyl acetate; a cellulose derivative such as carboxymethylcellulose or hydroxymethylcellulose; polyacrylamide or its derivative; polymethacrylamide or its derivative; and gelatin, casein or the like.

Still further, the water soluble polymers include anionic water soluble polymers such as polyalginic acid or its metal salt; carboxymethylcellulose or its metal salt; polyacrylic acid or its metal salt; a partial hydrolyzate of polyacrylamide or its metal salt; a maleic acid copolymer; lignin sulfonic acid or its metal salt or a derivative thereof; an oxy organic acid or its metal salt; an alkylallylsulfonic acid or its metal salt; a polyoxyalkyl allyl ether; a polyol complex; a higher polyhydric alcohol sulfonic acid or its metal salt; and a water soluble protein such as gelatin or glue or its metal salt or a derivative thereof.

As the water dispersion of water insoluble polymer, there can be mentioned, for example, a water dispersion of acrylic polymer (homopolymer or copolymer of acrylic ester and/or methacrylic ester), styrene/acrylic polymer (copolymer of styrene and acrylic ester and/or methacrylic ester), MBR polymer (methyl methacrylate/butadiene copolymer), SBR polymer (styrene/butadiene copolymer), urethane polymer, epoxy polymer or EVA polymer (ethylene/vinyl acetate copolymer). Whilst the organic particles of the present invention, like inorganic particles, form interparticulate voids so as to realize excellent ink absorptivity, the water dispersion mentioned here is not capable of forming voids and is added for the purpose of imparting binder functions. Accordingly, the glass transition temperature of the polymer is preferably 30° or below.

Among the above polymers having binder functions, a water dispersion of polyvinyl alcohol, cationized polyvinyl alcohol or acrylic polymer (homopolymer or copolymer of acrylic ester and/or methacrylic ester) is preferred from the viewpoint of excellence in yellowing resistance.

These polymers having binder functions are preferably incorporated in the layer in an amount of 0 to 20 parts by weight, still preferably 0 to 10 parts by weight, and yet still preferably 0 to 5 parts by weight, per 100 parts by weight of organic particles. When the amount of binder is in excess, the binder-polymer may fill up interparticulate voids so as to deteriorate the ink absorptivity of recording sheet.

It is preferred that the layer containing these organic particles substantially do not contain any inorganic pigment such as silica or alumina.

When an inorganic pigment is contained, not only the water repellency being the object of the present invention but also the light fastness and yellowing resistance may be deteriorated.

In addition, the layer containing organic particles according to the present invention may be loaded with an antistatic agent, an antioxidant, a dry paper strength additive, a wet paper strength additive, a waterproofing agent, an antiseptic agent, an ultraviolet absorber, a photostabilizer, a fluorescent brightener, a coloring pigment, a coloring dye, a penetrant, a blowing agent, a mold release agent, a foam inhibitor, a defoaming agent, a fluidity improver, a thickening agent, a pigment dispersant, a cationic fixer, etc.

The recording sheet of the present invention is not limited as long as at least one layer containing the above organic particles is superimposed on the sheet support on its recording surface side. In a preferred mode of arrangement, the layer containing the organic particles is used as a surface layer associated with the receiving of inks.

For example, the recording sheet of the present invention may have such a monolayer structure that only one layer containing organic particles according to the present invention is superimposed on the support. Alternatively, the recording sheet may have such a multilayer structure that the support is overlaid in sequence with an ink receptive layer and the layer containing organic particles according to the present invention, or overlaid in sequence with the layer containing organic particles according to the present invention and another layer.

It is preferred for the layer containing organic particles according to the present invention to constitute the uppermost surface layer of the recording surface side of the recording sheet from the viewpoint of most effective exertion of water repellency.

The basis weight of the layer containing organic particles according to the present invention superimposed on the sheet support is generally in the range of 1 to 300 g/m², which is however not particularly restrictive.

[Process for Producing Recording Sheet]

The recording sheet of the present invention can be produced by coating one major surface or both major surfaces of a sheet support with a coating composition containing organic particles and drying the coating composition so as to form a layer. The method of application of a coating composition in liquid form is not particularly limited, and use can be made of, for example, conventional application techniques by means of an air knife coater, a roll coater, a bar coater, a blade coater, a slide hopper coater, a gravure coater, a flexogravure coater, a curtain coater, an extrusion coater, a floating knife coater, a comma coater, a die coater or the like.

With respect to the recording sheet of the present invention, gloss may be imparted to the surface thereof.

In the present invention, the gloss refers to the glossiness at 75° of the recording surface of the recording sheet, measured in accordance with Japanese Industrial Standard (JIS) Z 8741. For example, the measuring can be effected by means of deformation gloss meter GM-3D (manufactured by Murakami Color Research Laboratory) or the like.

The recording sheet of the present invention can be glossy. The gloss at 75° is preferably 50% or higher. The gloss of below 50% is generally unsatisfactory.

The treatment method for imparting gloss is not particularly limited and known methods can be employed. For example, there can be employed the common calendering method wherein with the use of a calendar apparatus such as a supercalender or a gloss calender, the recording sheet is passed between rolls having pressure and heat applied thereto so as to smooth the surface of coating layer.

Further, there can preferably be employed the cast coating method, such as direct method, solidification method, rewetting method or precasting method, generally used in the production of cast coated paper for printing. The cast coating method refers to a method comprising holding a coating layer superimposed on a support in wet condition and compressing the coating layer to a heated specular roll so that the specular surface of the roll is transferred to the coating layer to thereby obtain gloss. The coating layer is dried while in contact with the roll.

In the direct method, the cast coating method wherein the coating layer in undried condition is compressed to a heated specular roll to thereby effect drying thereof is preferably employed.

In the cast coating method, the pressure at compression, the temperature of specular roll, the coating speed, etc. can be appropriately selected. In particular, it is preferred that the temperature of the specular roll be lower than the glass transition temperature of the organic particles. When the temperature of the specular roll is not lower than the glass transition temperature of the organic particles, voids may be likely to decrease to result in deterioration of ink absorptivity.

Effect of the Invention

In the present invention, a sheet for ink jet recording that not only reconciles gloss and ink absorptivity but also is excellent in color density, light fastness and yellowing resistance, in particular, exhibiting such a water repellency that print surfaces are protected from water by repelling thereof despite rapid absorption of inks can be provided by superimposing at least one layer containing organic particles on a sheet support on its recording surface side and by causing the organic particle containing layer to have specified liquid absorption characteristics.

Moreover, when the organic particles have a specified average particle diameter and a specified cationic property, there can be provided a sheet for ink jet recording whose ink absorptivity is strikingly excellent.

### EXAMPLE

The present invention will be further described below with reference to the following Examples, which however in no way limit the scope of the present invention. In the following Examples, the parts and % refer to parts by weight and % by weight, respectively, unless otherwise specified.

### Example 1

<Preparation of Organic Particles>

196.6 parts of deionized water and 0.5 part of stearyltrimethylammonium chloride were charged into a reaction vessel, and heated to 70° C. in a nitrogen stream. 0.5 part of 2,2′-azobis(2-amidinopropane) dihydrochloride was added to the mixture. Separately, 95 parts of styrene and 5 parts of 2-hydroxyethyl methacrylate were emulsified into 40 parts of deionized water in the presence of 0.3 part of stearyltrimethylammonium chloride to thereby obtain an emulsified mixture. This emulsified mixture was dropped into the above reaction vessel over a period of 4 hr. Thereafter, the vessel contents were maintained at the same temperature for 4 hr. Subsequently, 0.1 part of 2,2′-azobis(2-amidinopropane) dihydrochloride was added to the mixture and maintained at the same temperature for 3 hr to thereby complete the polymerization reaction.

As a result, an emulsion composition wherein organic particles were dispersed in water was obtained. The nonvolatile content thereof was 30%, and the pH value of the emulsion composition was 5. The average particle diameter determined by light scattering measurement was 95 nm. The glass transition temperature of organic particles determined from DSC curves in accordance with Japanese Industrial Standard (JIS) K 7121 was 102° C.

<Preparation of Recording Sheet>

A wood free paper of 105 g/m² basis weight was coated with the above emulsion composition having organic particles dispersed in water so that the coating amount was 20 g/m² in absolute dry condition, and dried at 60° C. for 30 min, thereby obtaining a recording sheet.

### Example 2

<Preparation of Recording Sheet>

The recording sheet obtained in Example 1 was compressed at a linear pressure of 100 kg/cm onto a specular roll having its surface temperature maintained at 75° C., thereby obtaining a glossy recording sheet.

### Example 3

<Preparation of Recording Sheet>

100 parts of synthetic amorphous silica (Fine Seal X-37B produced by Tokuyama Corporation) and 20 parts of completely saponified polyvinyl alcohol (PVA 117 produced by Kuraray Co., Ltd.) were added to water and mixed together under agitation, thereby obtaining a coating composition of 15% solid content. A wood free paper of 105 g/m² basis weight was coated with this coating composition so that the coating amount was 20 g/m² in absolute dry condition, and dried at 120° C. for 1 min. Further, the resultant coating layer was coated with the emulsion composition having organic particles dispersed in water, obtained in Example 1, so that the coating amount was 10 g/m² in absolute dry condition, and dried at 60° C. for 30 min. Thereafter, the resultant coating layer was compressed at a linear pressure of 100 kg/cm onto a specular roll having its surface temperature maintained at 75° C., thereby obtaining a recording sheet.

### Comparative Example 1

<Preparation of Organic Particles>

196.6 parts of deionized water and 0.5 part of stearyltrimethylammonium chloride were charged into a reaction vessel, and heated to 70° C. in a nitrogen stream. 0.5 part of 2,2′-azobis(2-amidinopropane) dihydrochloride was added to the mixture. Separately, 85 parts of methyl methacrylate, 5 parts of 2-hydroxyethyl methacrylate and 10 parts of n-butyl acrylate were emulsified into 40 parts of deionized water in the presence of 0.3 part of stearyltrimethylammonium chloride to thereby obtain an emulsified mixture. This emulsified mixture was dropped into the above reaction vessel over a period of 4 hr. Thereafter, the vessel contents were maintained at the same temperature for 4 hr. Subsequently, 0.1 part of 2,2′-azobis(2-amidinopropane) dihydrochloride was added to the mixture and maintained at the same temperature for 3 hr to thereby complete the polymerization reaction.

As a result, an emulsion composition wherein organic particles were dispersed in water was obtained. The nonvolatile content thereof was 30%, and the pH value of the emulsion composition was 5. The average particle diameter determined by light scattering measurement was 92 nm. The glass transition temperature of organic particles determined from DSC curves in accordance with Japanese Industrial Standard (JIS) K 7121 was 76° C.

<Preparation of Recording Sheet>

A wood free paper of 105 g/m² basis weight was coated with the above emulsion composition having organic particles dispersed in water so that the coating amount was 20 g/m² in absolute dry condition, and dried at 60° C. for 30 min. Thereafter, the resultant coating layer was compressed at a linear pressure of 100 kg/cm onto a specular roll having its surface temperature maintained at 75° C., thereby obtaining a recording sheet.

### Comparative Example 2

<Preparation of Recording Sheet>

100 parts of synthetic amorphous silica (Fine Seal X-37B produced by Tokuyama Corporation), 20 parts of completely saponified polyvinyl alcohol (PVA 117 produced by Kuraray Co., Ltd.) and 33.3 parts of Sumirez Resin 1001 (produced by Sumitomo Chemical Co., Ltd.; solid content 30%) were added to water and mixed together under agitation, thereby obtaining a coating composition of 15% solid content. A wood free paper of 105 g/m² basis weight was coated with this coating composition so that the coating amount was 20 g/m² in absolute dry condition, and dried at 120° C. for 1 min, thereby obtaining a recording sheet.

### Comparative Example 3

<Preparation of Recording Sheet>

100 parts of synthetic amorphous silica (Fine Seal X-37B produced by Tokuyama Corporation), 20 parts of completely saponified polyvinyl alcohol (PVA 117 produced by Kuraray Co., Ltd.) and 33.3 parts of Sumirez Resin 1001 (produced by Sumitomo Chemical Co., Ltd.; solid content 30%) were added to water and mixed together under agitation, thereby obtaining a coating composition of 15% solid content. A wood free paper of 105 g/m² basis weight was coated with this coating composition so that the coating amount was 20 g/m² in absolute dry condition, and dried at 120° C. for 1 min. Further, the resultant coating layer was coated with another coating composition of 15% solid content, the coating composition obtained by adding 1000 parts of colloidal silica (Snotex O produced by Nissan Chemical Industries, Ltd.; solid content 20%) and 20 parts of completely saponified polyvinyl alcohol (PVA 117 produced by Kuraray Co., Ltd.) to water and mixing them under agitation, so that the coating amount was 10 g/m² in absolute dry condition, and dried at 60° C. for 30 min. Thereafter, the resultant coating layer was compressed at a linear pressure of 100 kg/cm onto a specular roll having its surface temperature maintained at 75° C., thereby obtaining a recording sheet.

[Method of Evaluation]

The quality evaluation results for the obtained recording sheets are listed in Table 1. The evaluation was conducted in the following manner.

<Method of Measuring Contact Angle>

The measuring of contact angle was performed by the use of DAT (Dynamic Absorptivity Tester) 1100 or DAT MK11 manufactured by FIBRO. Practically, first, 4 μl of pure water or ink was dropped onto the recording surface of each recording sheet, and the change of state thereof after the dropping was captured on video. The cyan ink of color ink cartridge IC5CL5 usable in EPSON PM-800C was used as the ink. Thereafter, the video image taken at the passage of time predetermined for measuring was selected out, and the angle of contact of liquid drop lying on the recording surface was gauged on the video image.

<Method of Measuring Gloss>

In the gloss measurement, the level of gloss at 75° of the surface of each recording sheet was measured by means of deformation glossmeter (model GM-3D manufactured by Murakami Color Research Laboratory) in accordance with Japanese Industrial Standard (JIS) Z 8741.

<Method of Measuring Color Density>

Solid printing of black ink was effected on each recording sheet by means of commercially available ink jet printer (model PM2000C manufactured by Seiko Epson Corporation). The optical reflection density of solid part was measured by means of Macbeth densitometer (RD-918).

<Method of Measuring Ink Absorptivity>

Solid printing of each of yellow ink, magenta ink, cyan ink and black ink was effected in the longitudinal direction of recording sheet by means of commercially available ink jet printer (model PM2000C manufactured by Seiko Epson Corporation). Immediately after delivery from the printer, PPC paper was pressed onto the upper surface of the recording sheet, and the degree of transfer of ink from the recording sheet to the PPC paper was evaluated by visual inspection. Evaluation criterion was as follows.

◯: No ink transfer was observed, thereby attesting to excellent ink absorptivity.

Δ: Slight ink transfer was observed, but the ink absorptivity was on a practicable level.

×: Ink transfer was extensive, so that the ink absorptivity was below a practicable level.

<Method of Measuring Water Resistance>

Character printing with black ink was effected by means of commercially available ink jet printer (model PM2000C manufactured by Seiko Epson Corporation). City water of 30° C. was dropped on printed portion, and allowed to stand still for 1 hr. Thereafter, when any water drop remained thereon, it was sucked with waste. The condition of print, such as surface appearance or bleeding, was evaluated by visual inspection. Evaluation criterion was as follows.

⊚: Neither bleeding nor change of color density or surface appearance was observed at all.

◯: There was substantially no bleeding and was substantially no change of color density or surface appearance.

Δ: Bleeding and deterioration of color density or surface appearance were observed, but the water resistance was on a practicable level.

×: Bleeding and deterioration of color density or surface appearance were apparent, and the water resistance was below a practicable level.

<Method of Measuring Light Fastness>

Solid printing with magenta ink was effected by means of commercially available ink jet printer (model PM2000C manufactured by Seiko Epson Corporation). The recording sheet after printing was exposed to light for 100 hr by means of a xenon fadometer. The residual ratio of optical reflection density after light exposure to that before light exposure was measured and referred to as “light fastness”. The optical reflection density was measured by means of Macbeth densitometer (RD-918).

<Method of Measuring Yellowing Resistance>

Each recording sheet not subjected to printing was exposed to light for 7 hr by means of a carbon arc fadometer, and the difference between color before light exposure and color after light exposure was measured. The color difference (ΔE) in terms of L*a*b (expression method according to CIE) was calculated by the formula (ΔE)={(ΔL*)²+(Δa*)²+(Δb*)²}^{1/2} from the results of measuring of color before light exposure and color after light exposure. The larger the color difference, the higher the color deterioration.

The compositions, etc. of Examples and Comparative Examples are specified in Table 1, and the measurement results thereof are listed in Table 2.

TABLE 1

| | Composition | | | | | Tg | Particle | Layer | Surface |
|---|---|---|---|---|---|---|---|---|---|
| | St | HEMA | BA | MMA | Property | (° C.) | diam. (nm) | arrangement | treatment |
| Example 1 | 95 | 5 | | | cation | 102 | 95 | org. particle layer | not made |
| Example 2 | 95 | 5 | | | cation | 102 | 95 | org. particle layer | made |
| Example 3 | 95 | 5 | | | cation | 102 | 93 | org. particle | made |
| | | | | | | | | layer/silica layer | |
| Comp. Ex. 1 | | 5 | 10 | 85 | cation | 76 | 92 | org. particle layer | made |
| Comp. Ex. 2 | | | | | | | | silica layer | not made |
| Comp. Ex. 3 | | | | | | | | colloidal silica | made |
| | | | | | | | | layer/silica layer | |

TABLE 2

| | Contact angle (°) | | | | | | | | Light | Yellowing- |
|---|---|---|---|---|---|---|---|---|---|---|
| | water | water | Ink | Ink | Ink | | Gloss | Water | fastness | resistance |
| | (10 s later) | (1 m later) | (0.5 s later) | (1 s later) | absorptivity | Density | (75°) | resistance | (%) | (ΔE) |
| Example 1 | 120 | 120 | 15 | 9 | ◯ | 2.32 | 13 | ⊚ | 86.5 | 1.1 |
| Example 2 | 120 | 120 | 15 | 10 | ◯ | 2.35 | 73 | ⊚ | 88.3 | 1.1 |
| Example 3 | 120 | 120 | 9 | 6 | ◯ | 2.28 | 72 | ⊚ | 87.3 | 1.2 |
| Comp. Ex. 1 | 52 | 43 | 8 | 7 | ◯ | 2.35 | 71 | ◯ | 86.5 | 1.1 |
| Comp. Ex. 2 | 21 | 8 | 20 | 5 | ◯ | 1.68 | 8 | x | 61.3 | 1.4 |
| Comp. Ex. 3 | 28 | 22 | 12 | 7 | ◯ | 2.22 | 71 | Δ | 63.5 | 1.4 |

1. A sheet for ink jet recording, comprising:
a sheet support, and
at least one ink receptive layer containing organic particles, superimposed on a recording surface side of the sheet support,
which sheet for ink jet recording has a recording surface exhibiting an angle of contact of dropped water with the recording surface, measured 10 sec after dropping of 4 μl of pure water on the recording surface, of 90° or more and exhibiting an angle of contact of dropped ink with the recording surface, measured 1 sec after dropping of 4 μl of ink on the recording surface, of 30° or less.

2. The sheet for ink jet recording as claimed in claim 1, wherein the organic particles are those of at least one (co)polymer selected from among (meth)acrylic polymers ((meth)acrylic ester (co)polymers), styrene-(meth)acrylic polymers (styrene-(meth)acrylic ester copolymers), styrene polymers (styrene or styrene derivative (co)polymers), MBR polymers (methyl methacrylate-butadiene copolymer), SBR polymers (styrene-butadiene copolymer), urethane polymers, epoxy polymers, EVA polymers (ethylene-vinyl acetate copolymer), melamine polymers, urea polymers and olefinic polymers.

3. The sheet for ink jet recording as claimed in claim 1, wherein the organic particles are emulsion particles obtained by copolymerizing at least one monomer (A) selected from among styrene, t-butyl methacrylate, isobornyl acrylate, isobornyl methacrylate and isopropyl methacrylate with another monomer copolymerizable therewith (B).

4. The sheet for ink jet recording as claimed in claim 3, wherein on the basis of the total weight of at least one monomer (A) selected from among styrene, t-butyl methacrylate, isobornyl acrylate, isobornyl methacrylate and isopropyl methacrylate and another monomer copolymerizable therewith (B), the monomer (A) is used in an amount of 50 to 100% by weight while the monomer (B) is used in an amount of 0 to 50% by weight.

5. The sheet for ink jet recording as claimed in claim 4, wherein the copolymerizable monomer (B) does not contain any cationic monomer and wherein the organic particles are those polymerized with the use of a cationic initiator.

6. The sheet for ink jet recording as claimed in any of claims 1 to 5, wherein the organic particles are cationic organic particles.

7. The sheet for ink jet recording as claimed in any of claims 1 to 6, wherein the layer containing organic particles does not contain any inorganic pigment.
